(19) United States
(12) Patent Application Publication
(10) Pub. No.: US 2004/0084308 A1
(43) Pub. Date: May 6, 2004

(54) Gas sensor

(76) Inventors: Barrett E. Cole, Bloomington, MN (US); Robert E. Higashi, Shorewood, MN (US); Roland A. Wood, Bloomington, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/285,941

(22) Filed: Nov. 1, 2002

(51) Int. Cl. G01N 27/407

(52) U.S. Cl. 204/424; 204/426; 204/408; 205/781

(57) ABSTRACT

A low power gas sensor is provided for detecting one or more gases in a gas sample. The gas sensor includes a sensor for sensing a desired gas and a heater for heating the sensor. During operation, a controller provides power to the heater to heat the sensor to an operating temperature during a first period of time. Once at the operating temperature, the controller may read the sensor to determine a measure of the detected gas in the gas sample. Once a measurement is taken, and to conserve power, the controller removes the power to the heater allowing the heater and sensor to cool to at or near the ambient temperature for a second period of time. The second period of time may be longer than the first period of time, and in some cases, substantially longer. In some embodiments, the sensor and heater may be thermally isolated from some or all of the remainder of the gas sensor, such as the sensor substrate. This may also help reduce the amount of power that is required to heat the heater and sensor to the operating temperature. The gas sensor of the present invention may be ideally suited for battery powered and/or wireless applications.

### BACKGROUND OF THE INVENTION

This invention generally relates to gas sensors, and more specifically, to gas sensors for detecting one or more gases in a sample of an environment or flow stream.

There is growing interest in monitoring and controlling air quality in both indoor and outdoor environments. There are many gases that if discharged, can reduce the air quality including, for example, COx, NOx and SOx. There are several types of gas sensors that are commonly used to detect such gases. Many of these gas sensors include a material or material system that produces an electrical output signal that is related to the concentration of the detected gas. For example, solid electrolyte type sensors typically produce an electromotive force (EMF) when the concentration of the gas to be sensed changes. Solid electrolyte type sensors typically have a solid electrolyte layer that is an ionic conductor, a work electrode layer that contains an electron conducting material and an auxiliary electrode material, a reference electrode layer containing an electron conducting material, and a heater for heating the layers. Other configurations can also be used.

During operation, the heater of the solid electrolyte type sensor is typically used to heat the solid electrolyte layer to an operating temperature. Once heated, the sensor produces an electromotive force between the work electrode layer and the reference electrode layer through the solid electrolyte layer, depending on the concentration of the detected gas. When the concentration of the detected gas changes, a dissociation equilibrium reaction occurs between the auxiliary electrode material contained in the work electrode layer and the detected gas until equilibrium is reached and the concentration of movable ions in the solid electrolyte layer changes in the vicinity of the work electrode. Since the concentration change appears as a change in electromotive force, the concentration of the detected gas can be determined.

A limitation of many prior art gas sensors is that the sensor is thermally coupled to a substrate or other similar thermal heat sink layer or material. Thus, the power required to heat the sensor can be considerable. Another limitation of many prior art gas sensors is that the sensor is continuously heated. This also can consume considerable power. These and other limitations make many prior art gas sensors less than desirable for low power applications.

### SUMMARY OF THE INVENTION

The present invention is directed toward a gas sensor, and more specifically, a gas sensor for detecting one or more gases in a gas sample. The gas sensor includes a sensor for sensing a desired gas and a heater for heating the sensor. During operation, a controller provides power to the heater to heat the sensor to an operating temperature, which is above ambient temperature. The application of heat to the sensor preferably increases the sensitivity of the sensor.

In some embodiments, a controller provides power to the heater to heat the sensor to the operating temperature during a first period of time. Once at the operating temperature, the controller reads the sensor to determine a measure of the detected gas in the gas sample. Once a measurement is taken, and to conserve power, the controller may remove the power to the heater allowing the heater and sensor to cool to at or near the ambient temperature for a second period of time. The second period of time may be longer than the first period of time, and in some cases, substantially longer.

In some embodiments, the sensor and heater are thermally isolated from some or all of the remainder of the sensor, such as the sensor substrate. This may help reduce the amount of power that is required to heat the heater and sensor to the operating temperature. The gas sensor of the present invention may be ideally suited for battery powered and/or wireless applications.

### BRIEF DESCRIPTION OF THE DRAWINGS

FIG. 1 is a cross-sectional side view of an illustrative gas sensor in accordance with the present invention;

FIG. 2 is a schematic top view of the illustrative gas sensor of FIG. 1;

FIG. 3 is a cross-sectional side view of another illustrative gas sensor in accordance with the present invention;

FIG. 4 is a timing diagram showing heater current versus time for one illustrative embodiment of the present invention;

FIG. 5 is a timing diagram showing sensor temperature versus time for one illustrative embodiment of the present invention; and

FIG. 6 is a schematic side view of an illustrative gas sensor assembly in accordance with the present invention.

### DETAILED DESCRIPTION OF THE INVENTION

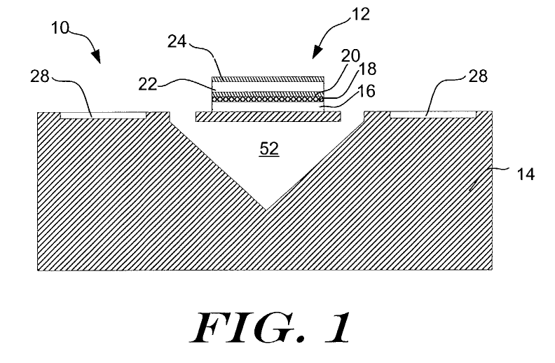

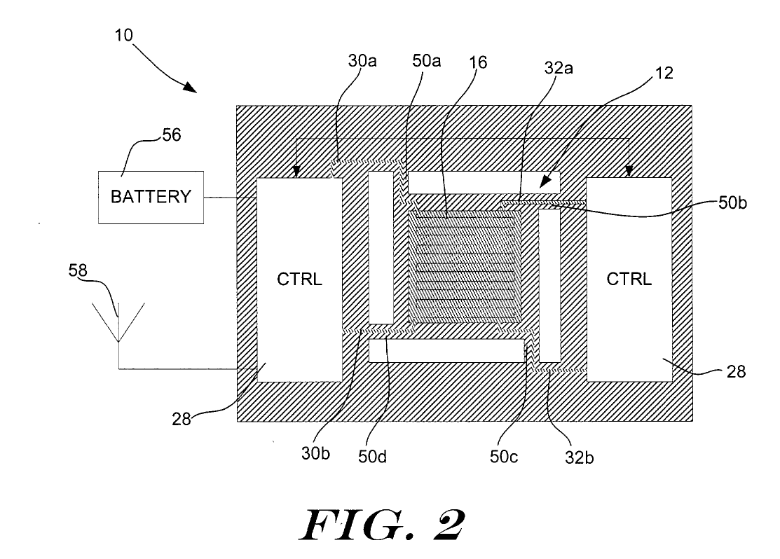

The present invention is directed toward a gas sensor, and more specifically, a gas sensor for detecting one or more gases in a gas sample. FIG. 1 is a cross-sectional side view of one illustrative gas sensor in accordance with the present invention. FIG. 2 is a schematic top view of the illustrative gas sensor of FIG. 1. The illustrative gas sensor is generally shown at 10, and includes a sensor 12 formed on or above a substrate 14. The illustrative sensor 12 includes a heater layer 16, a buffer layer 18, a lower electrode layer 20, a solid electrolyte layer 22, and an upper electrode layer 24, as best shown in FIG. 1. It should be understood that the specific layers shown, as well as their relative positions, may be changed and still be within the scope of the present invention. All that is important is that the heater layer 16 is thermally coupled to the solid electrolyte layer 22, and contacts are provided from the solid electrolyte layer 22.

The heater layer 16 is preferably made from a resistive material that generates heat when a current is passed therethrough. To increase the heat the can be delivered to the sensor 12, the heater layer 16 may be configured to meander back and fourth along the area of the sensor 12, as better shown in FIG. 2. The solid electrolyte layer is preferably made from a suitable solid electrolyte material. For example, if the gas to be detected is CO₂, the solid electrolyte may be NASICON, NaBaCO₃, or any other suitable electrolyte material.

Control electronics 28 may be provided on or in the substrate 14. Control electronics 28 are preferably coupled to the heater layer 16 via traces 30a and 32b, and the lower electrode layer 20 and the upper electrode layer 24 via traces 32a and 32b, as best shown in FIG. 2. During operation, control electronics 28 preferably provide power to the heater layer 16 to heat the sensor 12 to an operating temperature, which is above an ambient temperature. The application of heat to the sensor 12, and more specifically, to the solid electrolyte layer 22, preferably increases the sensitivity of the sensor to the detected gas.

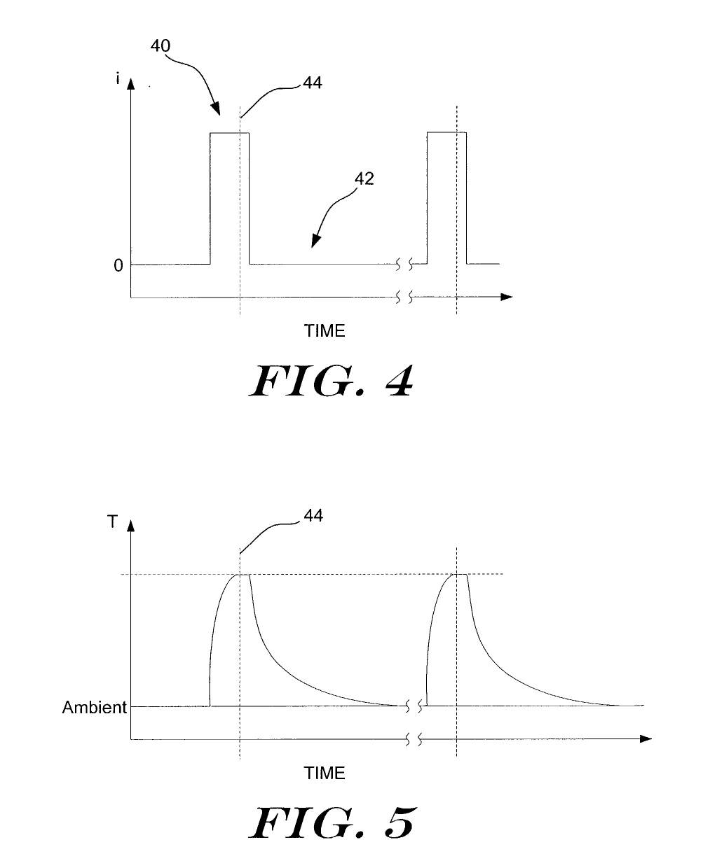

Referring to FIG. 4, and in one embodiment of the present invention, the control electronics 28 may provide power to the heater layer 16 to heat the sensor to the operating temperature during a first period of time, such as a first period of time 40 shown in FIG. 4. Once at the operating temperature, the control electronics 28 may read the voltage across the solid electrolyte layer 22, via the lower electrode layer 20 and the upper electrode layer 24, to determine a measure of the detected gas in the gas sample. The measurement may be taken at, for example time 44 shown in FIG. 4. Once a measurement is taken, and to conserve power and/or increase the useful lifetime of the sensor, the control electronics may remove the power to the heater layer 16, allowing the heater layer 16 and the solid electrolyte layer 22 to cool to at or near the ambient temperature for a second period of time. The second period of time is shown at 42 in FIG. 4. The resulting temperature versus time of the sensor 12 is shown in FIG. 5. The control electronics 28 may periodically or intermittently provide power to the heater layer 16 to heat the sensor to the operating temperature, as best shown in FIGS. 4-5.

The second period of time 42 is preferably longer than the first period of time 40, and in some cases, substantially longer. For example, the first period of time 40 may be on the order of hours, minutes, seconds or even shorter, depending on the application, while the second period of time 42 may be on the order of days, hours or minutes. Generally, the greater the difference between the first and second periods of time, the greater the power savings. In addition, because aging effects for some sensors occur faster at higher temperatures, the useful lifetime of the sensor may be extended by having a longer second period of time.

In some embodiments, the sensor 12 may be thermally isolated from some or all of the remainder of the gas sensor 10. In the embodiment shown in FIG. 1, a pit 52 is etched into the substrate below the sensor 12 leaving a gap between the sensor 12 and the substrate 14. The gap may be an air gap, or filled with a material that has a material that has a low coefficient of thermal conductivity. Supporting legs 50a-d may be left in tact to support the sensor 12 above the pit 52. In this configuration, the sensor 12, which includes the heater 16 and the solid electrolyte layer 22, are suspended above the substrate by a gap, which helps thermally isolate the sensor 12 from the remainder of the gas sensor 10. This may help reduce the amount of power and time that is required to heat the sensor 12 to the operating temperature.

Because the amount of power required to heat the sensor 12 to the operating temperature is reduced, and/or because the sensor 12 is only heated when a reading is desired, the gas sensor 10 may be ideally suited for battery powered and/or wireless applications. For example, the control electronics 28 may be powered by a battery 56, and/or the control electronics 28 may wirelessly transmitting an output signal from the gas sensor 10 via an antenna 58.

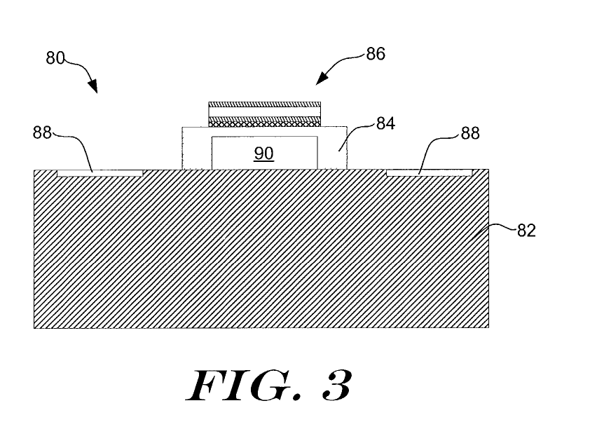

FIG. 3 is a cross-sectional side view of another illustrative gas sensor in accordance with the present invention. The illustrative gas sensor is generally shown at 80, and includes a substrate 82, a support structure 84, a sensor 86 and control electronics 88. This embodiment is similar to that shown and described above with respect to FIGS. 1-2. However, rather than suspending the sensor above an etched pit 52 in the substrate, as shown in FIG. 1, a support structure is provided on the substrate that suspends the sensor 86 above the substrate 82. A gap 90 or the like may be provided below the support structure 84 to help provide thermal isolation. Alternatively, or in addition, the support structure 84 may be formed from a material that has a low coefficient of thermal conductivity. Regardless of which approach is used, the sensor 10 and sensor 86 are thermally isolated from the substrate.

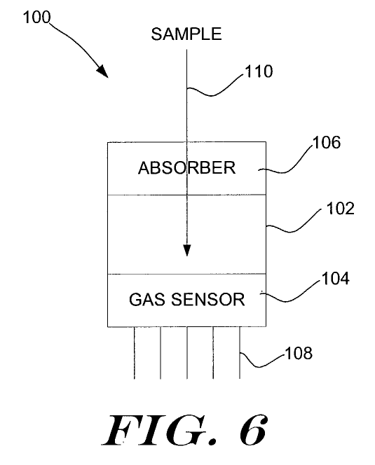

FIG. 6 is a schematic side view of an illustrative gas sensor assembly in accordance with the present invention. The gas sensor assembly is generally shown at 100, and includes a housing 102, a gas sensor 104, and an absorber 106. The gas sensor may be similar to those shown and described above with respect to FIGS. 1-5.

A gas sample 110 from an environment is provided to the gas sensor 104 through the absorber 106. The absorber preferably includes an absorbent material that absorbs unwanted constituents or gases from the sample 110 before the sample 110 reaches the gas sensor 104. For example, the absorber may absorb unwanted water or one or more interference gases. In some cases, unwanted water can reduce the effectiveness of the solid electrolyte layer of the gas sensor 104. Likewise, interference gases can sometimes reduce the reliability or accuracy of the measurements made by the gas sensor 104.

The gas sensor assembly 100 may further include a number of leads 108. The leads 108 may provide a mechanical and/or electrical connection between the gas sensor assembly 100 and an external board or the like, when desired.

Numerous advantages of the invention covered by this document have been set forth in the foregoing description. It will be understood, however, that this disclosure is, in many respects, only illustrative. Changes may be made in details, particularly in matters of shape, size, and arrangement of parts without exceeding the scope of the invention. The invention's scope is, of course, defined in the language in which the appended claims are expressed.

What is claimed is:

1. A gas sensor for sensing a gas in a sample, comprising:
a substrate;
sensing means for sensing the gas, the sensing means including a material or material system that is more sensitive to the gas when heated to an operating temperature that is above an ambient temperature;
heating means for heating the sensing means to the operating temperature;
control means coupled to the heating means and the sensing means, the control means heating the heating means so that the sensing means reaches the operating temperature for a first period of time, wherein the sensing means senses the gas, the control means then allowing the heating means to cool to at or near the ambient temperature for a second period of time.

2. A gas sensor according to claim 1 wherein the second period of time is substantially longer than the first period of time.

3. A gas sensor according to claim 1 wherein the material or material system of the sensing means includes a solid electrolyte.

4. A gas sensor according to claim 3 wherein the solid electrolyte includes NASICON.

5. A gas sensor according to claim 3 wherein the solid electrolyte includes NaBaCO₃.

6. A gas sensor according to claim 1 wherein at least part of the sensing means and the heating means are thermally isolated from the substrate.

7. A gas sensor according to claim 6 wherein at least part of the sensing means and heating means are suspended above the substrate.

8. A gas sensor according to claim 1 wherein the control means provides a current to the heating means to heat the heating means during the first period of time.

9. A gas sensor according to claim 8 wherein the control means removes all or substantially all of the current to the heating means during the second period of time.

10. A gas sensor according to claim 1 wherein the control means is powered by a battery.

11. A gas sensor according to claim 1, wherein the control means is coupled to the sensing means and provides a sensor output signal.

12. A gas sensor according to claim 11, wherein the control means receives a signal from the sensor means, and wirelessly transmits the sensor output signal via an antenna.

13. A gas sensor according to claim 1 further comprising an absorbent material for absorbing an unwanted constituent from the sample before the sample reaches the sensing means.

14. A gas sensor according to claim 13 wherein the unwanted constituent includes water.

15. A gas sensor according to claim 13 wherein the unwanted constituent includes one or more interference gases.

16. A gas sensor for sensing a gas in a sample, comprising:
a substrate;
sensing means for sensing the gas, the sensing means including a material or material system that is more sensitive to the gas when heated to an operating temperature that is above an ambient temperature;
heating means for heating the sensing means to the operating temperature;
wherein at least part of the sensing means and the heating means are thermally isolated from the substrate; and
control means coupled to the heating means and the sensing means, the control means heating the heating means such that the sensing means reaches the operating temperature for a first period of time, wherein the sensing means senses the gas, the control means then allowing the heating means to cool for a second period of time.

17. A gas sensor according to claim 16 wherein the second period of time is substantially longer than the first period of time.

18. A gas sensor according to claim 16 wherein the material or material system of the sensing means includes a solid electrolyte.

19. A gas sensor according to claim 16 wherein at least part of the sensing means and heating means are suspended above the substrate.

20. A gas sensor according to claim 16 wherein the control means is powered by a battery.

21. A gas sensor according to claim 16, wherein the control means is coupled to the sensing means and provides a sensor output signal, and wirelessly transmits the sensor output signal via an antenna.

22. A gas sensor according to claim 16 further comprising an absorbent material for absorbing an unwanted constituent from the sample before the sample reaches the sensing means.

23. A gas sensor according to claim 22 wherein the unwanted constituent includes water.

24. A gas sensor according to claim 22 wherein the unwanted constituent includes one or more interference gases.

25. A method for sensing a gas, the method comprising the steps of:
providing a sensor for sensing the gas, the sensor including a material or material system that is more sensitive to the gas when heated to an operating temperature that is above an ambient temperature;
heating the sensor to the operating temperature for a first period of time;
allowing the sensor to cool to at or near the ambient temperature for a second period of time; and
repeating the heating and cooling steps.

26. A method according to claim 25 wherein the sensing means is secured to, but spaced from, a substrate.

27. A method according to claim 25 further comprising the steps of:
receiving a signal from the sensor means when the sensor is heated at the operating temperature; and
wirelessly transmitting a sensor output signal that corresponds to the signal received from the sensor.
